(19) United States
(12) Patent Application Publication
(10) Pub. No.: US 2006/0112875 A1
(43) Pub. Date: Jun. 1, 2006

(54) Apparatus for coating 2-D or 3-D extrusion materials with paint and coating method using the same

(76) Inventors: Yu Huh, Cheongju-si (KR); Chang-Wook Seo, Cheongju-si (KR)

Correspondence Address: CANTOR COLBURN, LLP, 55 GRIFFIN ROAD SOUTH, BLOOMFIELD, CT, 06002, US

(21) Appl. No.: 11/186,067

(22) Filed: Jul. 21, 2005

(30) Foreign Application Priority Data
Nov. 26, 2004 (KR) 10-2004-0098034
Mar. 31, 2005 (KR) 10-2005-0027202

(51) Int. Cl. B05C 11/00; B05C 11/02

(52) U.S. Cl. 118/712; 118/668; 118/104

(57) ABSTRACT

The present invention is directed to an apparatus for coating a surface of a 2-D or 3-D extrusion material, which comprises a rail unit installed on a base with an elastic member interposed therebetween to be elastically and vertically movable, thereby serving to isolate a coating surface and a non-coating surface from each other while elastically supporting the delivered 2-D or 3-D extrusion material; a coating unit for applying a certain amount of coating liquid to the specific coating surface of the extrusion material at random; and an air knife for blowing air at a constant pressure to the coating liquid applied onto the extrusion material and diffusing the coating liquid to apply the coating liquid at a uniform thickness on the coating surface of the extrusion material. Further, the present invention is also directed to a method for coating a surface of a 2-D or 3-D extrusion material, comprising the steps of applying a certain amount of a coating material to the specific surface of the 2-D or 3-D extrusion material at random; coating the surface of the extrusion material with the coating liquid at an uniform thickness by blowing air at a constant pressure to the coating liquid applied onto the extrusion material and diffusing the coating liquid, wherein the coating liquid is prevented from flowing in the non-coating surface by blowing air from the non-coating surface to the coating surface of the extrusion material; and curing the coating liquid by applying heat or irradiating ultraviolet rays to the coating liquid.

### BACKGROUND OF THE INVENTION

1. Field of Invention

The present invention relates to an apparatus for coating a single surface or multiple surfaces of 2-D or 3-D extrusion material with paint and a coating method using the same.

2. Description of the Prior Art

For the purpose of understanding, the extrusion molding and extrusion materials manufactured by the molding process will be defined. The extrusion molding is a method for continuously molding a product by extruding liquid resin to a die using a plunger to form a preform of a predetermined shape and then by cooling and solidifying the perform, wherein the liquid resin is obtained by heating polymeric or thermoplastic resin in the form of powders at its melting or softening point or above. The product manufactured by such a method is called an extrusion material.

As an example of a method for coating a surface of the aforementioned extrusion material such as a sash or window frame, the spray coating, roll coating, dip coating or the like has been well known in the art.

Among them, the spray coating, which is performed by spraying coating liquid at high pressure onto a surface to be coated using a spray gun, has an advantage in that a single surface coating and a multi-surface coating can be made. However, a non-coating portion should be masked in order to coat only a desired portion. In addition, due to the nature of a spraying method, an amount of coating liquid sprayed onto a peripheral portion is larger than that sprayed onto the surface to be coated, and thus a great loss of coating material can be produced. Since the coating material should be relatively low in viscosity in order to be smoothly sprayed, a diluent must be added to the coating material. Further, since a process of evaporating the diluent is also necessary as a post process, there is a disadvantage in that the man-hour needed for the works is increased.

The roll coating, which is performed by causing a coating roll with a coating liquid smeared thereon to roll over the surface to be coated, can be advantageously applied to a 2-D plane product. However, due to the nature of the coating roll, there is a limitation in that a smaller portion or a narrower surface cannot be precisely coated. Thus, it is difficult to coat a 3-D product having a complicated or uneven shape.

The dip coating, which is a coating method for forming a paint film on a material by dipping the material to be coated into a solution in which materials forming the paint film are dissolved or dispersed and then pulling it out, is suitable for the entire coating of the material to be coated, but not suitable for the partial coating of the material to be coated.

In addition to the aforementioned coating methods, there is a transferring method. Since a coating film formed by the transferring method has weak adhesive strength, the coating film may come off the surface onto it has been coated. In order to increase the adhesion strength, a primer should be used as an adhesion medium. Further, since the coating film can be easily scratched, severe deterioration and damage thereof occurs after its long time use. Thus, it is known that the coating film formed by the transferring method is not durable.

The aforementioned transferring method is disclosed in Korean Patent Application Nos. 10-1999-68110, 10-1999-68111 and 10-2002-71655, all of which propose only a method for coating a 2-D plane. That is, judging from the fact that the documents are silent to a method for coating a desired portion or a 3-D shape, it is presumed that it is impossible to apply the proposed coating methods to a 3-D product or difficult to implement the proposed coating methods, although possible.

### SUMMARY OF THE INVENTION

Accordingly, the present invention is conceived to solve the aforementioned problems in the prior art. A main object of the present invention is to provide an apparatus for simply coating a surface or multiple surfaces of a 2-D or 3-D extrusion material using a method other than the aforementioned coating methods, and a coating method using the same.

Another object of the present invention is to provide an apparatus for coating a 2-D or 3-D extrusion material and a coating method using the same, wherein the coating quality can be enhanced by improving the sealing function between a coating surface and a non-coating surface such that coating liquid is not spread from the coating surface to the non-coating surface when the 2-D or 3-D extrusion material is coated.

According to a first aspect of an apparatus of the present invention for achieving the objects, there is provided an apparatus for coating a surface of a 2-D or 3-D extrusion material, which comprises a rail unit installed on a base with an elastic member interposed therebetween to be elastically and vertically movable, thereby serving to isolate a coating surface and a non-coating surface from each other while elastically supporting the delivered 2-D or 3-D extrusion material; a coating unit for applying a certain amount of coating liquid to the specific coating surface of the extrusion material at random; and an air knife for blowing air at a constant pressure to the coating liquid applied onto the extrusion material and diffusing the coating liquid to apply the coating liquid at a uniform thickness on the coating surface of the extrusion material.

According to a second aspect of an apparatus of the present invention, there is provided an apparatus for coating a surface of a 2-D or 3-D extrusion material, which comprises a rail unit including a fixed rail fixedly installed on a base and a movable rail installed on the fixed rail to be elastically and vertically movable by an elastic member, thereby serving to isolate a coating surface and a non-coating surface from each other while elastically supporting the 2-D or 3-D extrusion material; a coating unit for applying a certain amount of coating liquid to the specific coating surface of the extrusion material at random; and an air knife for blowing air at a constant pressure to the coating liquid applied onto the extrusion material and diffusing the coating liquid to apply the coating liquid at a uniform thickness on the coating surface of the extrusion material.

According to a third aspect of an apparatus of the present invention, there is provided an apparatus for coating a surface of a 2-D or 3-D extrusion material, which comprises a rail unit mounted with an elastic member for isolating a coating surface and a non-coating surface from each other at a portion on which the 2-D or 3-D extrusion material is supported; a coating unit for applying a certain amount of coating liquid to the specific coating surface of the extrusion material at random; and an air knife for blowing air at a constant pressure to the coating liquid applied onto the extrusion material and diffusing the coating liquid to apply the coating liquid at a uniform thickness on the coating surface of the extrusion material.

According to a fourth aspect of an apparatus of the present invention, there is provided an apparatus for coating a surface of a 2-D or 3-D extrusion material, which comprises a rail unit including an air nozzle directed to a boundary between a coating surface and a non-coating surface of the 2-D or 3-D extrusion material; an air supply means for supplying the air nozzle with air; a coating unit for applying a certain amount of coating liquid to the specific coating surface of the extrusion material at random; and an air knife for blowing air at a constant pressure to the coating liquid applied onto the extrusion material and diffusing the coating liquid to apply the coating liquid at a uniform thickness on the coating surface of the extrusion material.

According to a first aspect of a method of the present invention for achieving the objects, there is provided a method for coating a surface of a 2-D or 3-D extrusion material, which comprises the steps of applying a certain amount of a coating material to the specific surface of the 2-D or 3-D extrusion material at random; coating the surface of the extrusion material with the coating liquid at an uniform thickness by blowing air at a constant pressure to the coating liquid applied onto the extrusion material and diffusing the coating liquid in a state where a coating surface and a non-coating surface of the extrusion material are isolated from each other; and curing the coating liquid by applying heat or irradiating ultraviolet rays to the coating liquid.

According to a second aspect of a method of the present invention, there is provided a method for coating a surface of a 2-D or 3-D extrusion material, which comprises the steps of applying a certain amount of a coating material to the specific surface of the 2-D or 3-D extrusion material at random; coating the surface of the extrusion material with the coating liquid at an uniform thickness by blowing air at a constant pressure to the coating liquid applied onto the extrusion material and diffusing the coating liquid, wherein the coating liquid is prevented from flowing in the non-coating surface by blowing air from the non-coating surface to the coating surface of the extrusion material;

and curing the coating liquid by applying heat or irradiating ultraviolet rays to the coating liquid.

### BRIEF DESCRIPTION OF THE DRAWINGS

The above and other objects, features and advantages of the present invention will become apparent from the following description of a preferred embodiment given in conjunction with the accompanying drawings, in which:

FIG. 1 is a view showing first equipment for manufacturing extrusion materials including a coating apparatus of the present invention;

FIG. 2 is a view showing second equipment for manufacturing extrusion materials including the coating apparatus of the present invention;

FIG. 3 is a perspective view of the coating apparatus according to the present invention;

FIG. 4 is a side view of the coating apparatus according to the present invention before extrusion materials are introduced therein;

FIG. 5 is a perspective view of the major portion of FIG. 4;

FIG. 6 is a side view of the coating apparatus according to the present invention while extrusion materials are being coated;

FIG. 7 is a perspective view of the major portion of FIG. 6;

FIG. 8 is a sectional view taken along line I-I of FIG. 6;

FIG. 9 is a view showing a state where an elastic member has been compressed;

FIG. 10 is a view showing a second embodiment of a rail unit according to the present invention;

FIG. 11 is a view showing a third embodiment of the rail unit according to the present invention;

FIG. 12 is a view showing a fourth embodiment of the rail unit according to the present invention;

FIG. 13 is a view showing a state where the rail unit of FIG. 12 is installed; and

FIG. 14 is a flowchart illustrating a coating method according to the present invention.

### DETAILED DESCRIPTION OF THE PREFERRED EMBODIMENT

Hereinafter, preferred embodiments of the present invention will be described in detail with reference to the accompanying drawings.

When describing the present invention, an apparatus and a method will be described separately.

First, a coating apparatus for coating a 2-D or 3-D extrusion material with paint according to the present invention is included in the equipment for manufacturing an extrusion material. The configuration of first and second equipment for manufacturing an extrusion material including the coating apparatus is described as follows.

However, it is assumed that the first and second equipment for manufacturing extrusion materials may vary according to circumstances.

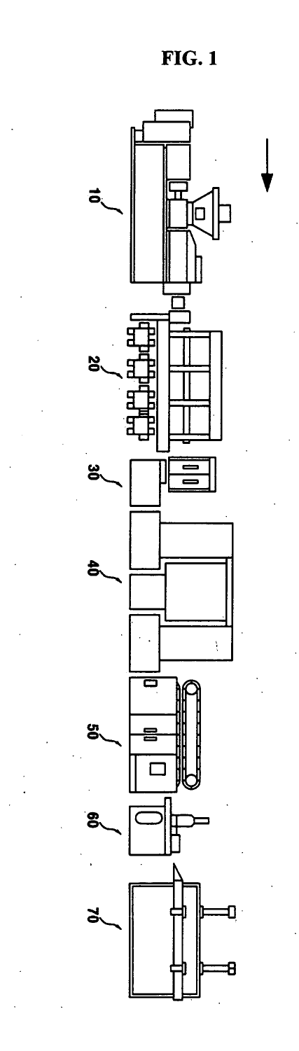

As shown in FIG. 1, the first equipment for manufacturing an extrusion material comprises an extruding apparatus 10 for extrusion molding molten thermoplastic resin into a 2-D or 3-D shape; a shape-setting apparatus (or calibration unit) 20 for maintaining the shape of the extrusion material, which is not yet cured, by vacuum holding the surface of the extrusion material in order to prevent the extrusion material from being deformed; a coating apparatus 30 for coating desired portions of the extrusion material with a coating material; a curing apparatus 40 for curing the coating material; a withdrawing apparatus 50 for withdrawing the coated extrusion material to the outside; a cutting apparatus 60 for cutting the withdrawn extrusion material into an appropriate size; and a stacker 70 for sorting and stacking the cut extrusion material.

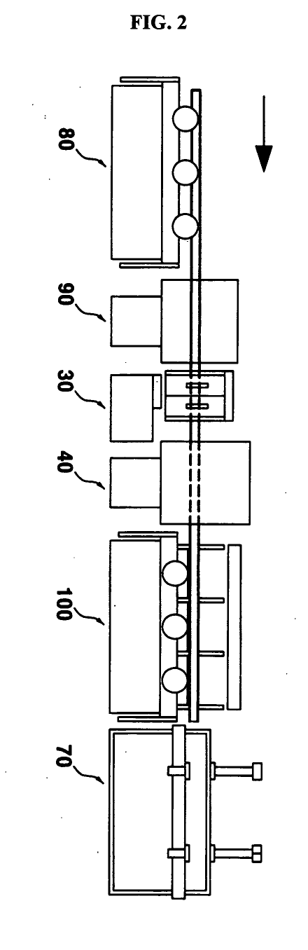

Second, as shown in FIG. 2, the second equipment for manufacturing an extrusion material comprises an input apparatus 80 for inputting a curable extrusion material which has been extrusion molded into a 2-D or 3-D shape and cut into an appropriate size; a cleaning apparatus 90 for cleaning the input extrusion material; a coating apparatus 30 for coating desired portions of the extrusion material with a coating material; a curing apparatus 40 for curing the coating material; a delivery apparatus 100 for delivering the extrusion material; and a stacker 70 for sorting and stacking the extrusion material.

Here, four embodiments of the coating apparatus 30 commonly included in the respective manufacturing equipment are described.

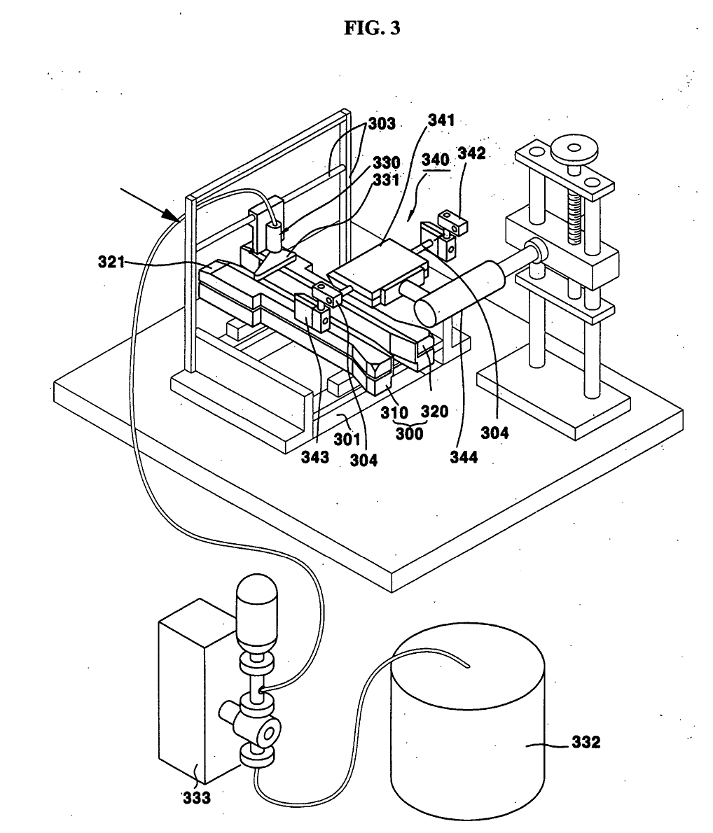

As shown in FIGS. 3 to 9, a first embodiment of the coating apparatus includes a rail unit 300 that comprises fixed rails 310 fixedly installed on a base 301 and movable rails 320 which are installed on upper portions of the fixed rails to be elastically, vertically moved by elastic members 302 and serve to elastically support an extrusion material 1 of a 2-D or 3-D shape and to separate a coating surface 1a and an non-coating surface 1b from each other. Here, the extrusion material 1 may include a product of 3-D shape such as a sash or window frame or a product of 2-D shape such as a cover (not shown) fitted in a surface of a window frame.

Since the rail unit is urged toward and brought into close contact with the extrusion material 1 due to an elastic force of the elastic members 302 installed between the rail unit and the base 301, no gap g occurs between the rail unit and the extrusion material. Thus, the coating surface 1a and the non-coating surface 1b are isolated from (more specifically, sealed from) each other. The reason that the coating surface and the non-coating surface are isolated from each other is that a coating material is prevented from being introduced into the non-coating surface. In addition, since an upper end of an inlet side (designated by ‘in’) of the rail unit 300 is gently inclined, the extrusion material 1 is not caught thereon and can be smoothly introduced therein when the extrusion material 1 is initially introduced in the rail unit.

Further, a coating unit 330 for applying a certain amount of coating liquid to a specific surface (the uppermost surface) of the extrusion material at random is provided. At this time, the coating unit includes a coating liquid injection nozzle 331 installed over the upper surface of the extrusion material 1, a coating liquid storage tank 332 for storing the coating liquid therein, and a pulseless metering pump 333 for supplying the coating liquid injection nozzle with the coating liquid in the coating liquid storage tank through a tube.

The pulseless metering pump 333 serves to pump the coating liquid in order to spout a certain amount of the coating liquid without pulsation thereof. Since a pulsating pump periodically distributes the coating liquid, the thickness of the coating can be irregular. Thus, it is preferred that the pulsating pump be excluded in practice although it can be theoretically utilized.

The coating liquid injection nozzle 331 is installed on a support 303 mounted on the base 301 such that the coating liquid injection nozzle 331 can be moved from side to side and adjusted upward and downward. Thus, it is possible to adjust a position and angle of the coating liquid injection nozzle 331 according to the extrusion materials used.

In addition, there is also provided an air knife 340 which diffuses the coating liquid C by constantly blowing air to the coating liquid applied on the extrusion material 1 and thus causes the coating liquid to be applied thereon at a uniform thickness.

Here, the air knife includes an upper side air knife 341 for blowing air to an upper surface of the extrusion material 1, a first side air knife 342 for blowing air to a side surface of the extrusion material 1, and a second side air knife 343 for blowing air to another side surface of the extrusion material 1. The upper side air knife 341, the first side air knife 342, and the second side air knife 343 are installed on a support 304 such that their positions and angles can be adjusted.

The air knife 340 blows laminar-flow air such that a surface of the extrusion material 1 can be uniformly coated. At this time, a certain amount of the laminar-flow air with a certain pressure is supplied to a desired portion to be coated, wherein the pressure and amount of the air should be determined in consideration of the thickness of the coating portion, the degree of the coating texture to be expressed, the property or processing temperature of the extrusion material, or the like.

Hereinafter, the working process of the aforementioned first embodiment will be described.

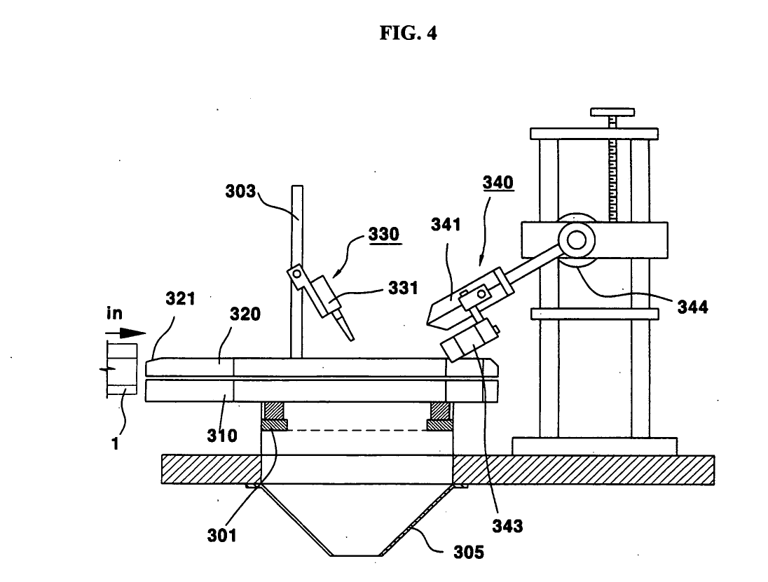

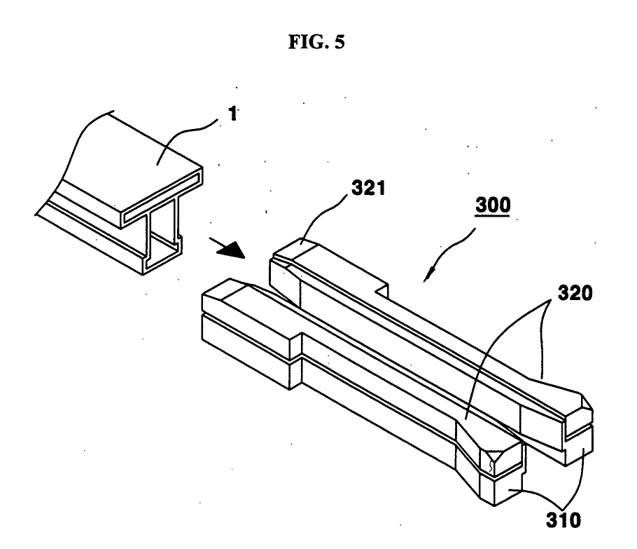

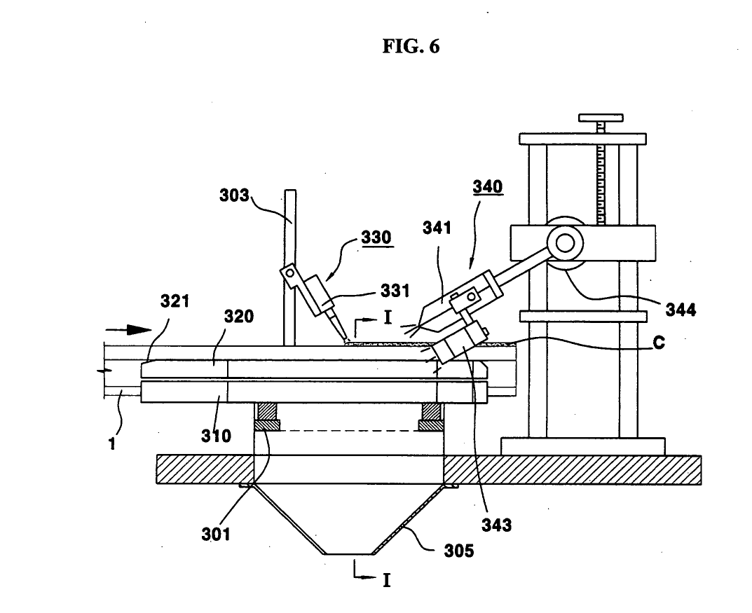

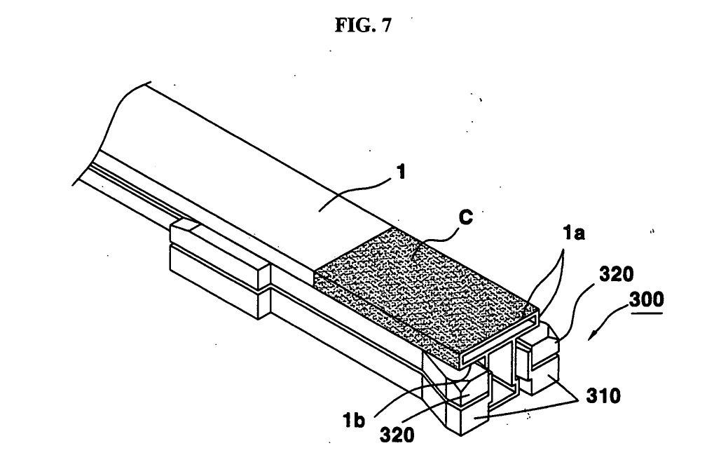

As shown in FIGS. 4 and 5, when the extrusion material 1 that has been extrusion molded into a 2-D or 3-D shape is delivered toward the coating apparatus, the extrusion material 1 is guided along the rail unit while conforming to the rail unit 300 manufactured with a shape corresponding to that of the extrusion material. At this time, since the upper end of the inlet side of the rail unit is formed with a gently inclined surface 321, the extrusion material is not caught thereon and smoothly introduced in the rail unit. As shown in FIGS. 6 and 7, while the extrusion material 1 is delivered along the rail unit 300, the coating liquid injection nozzle 331 installed at the inlet side of the rail unit applies the coating liquid to the surface of the extrusion material 1 at random. That is, the coating liquid stored in the coating liquid storage tank 332 is discharged to the coating liquid injection nozzle 331 by means of a pumping force of the pulseless metering pump 333. The discharged coating liquid is applied to the uppermost surface of the extrusion material 1.

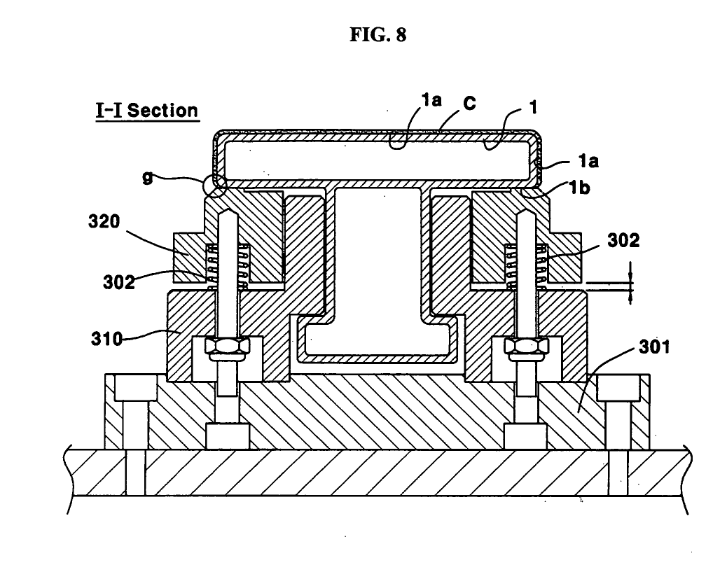

The constant pressure air, which is blown from the air knife 340 installed at a certain angle in the rear portion of the rail unit 300, causes the applied coating liquid C to be uniformly diffused on the upper surface of the extrusion material 1 and thus to be coated thereon at a uniform thickness. If upper and both side surfaces (3-D surface) of the extrusion material should be coated, the coating material spread over the upper surface of the extrusion material by the air pressure of the air knife flows down to both side surfaces of the extrusion material. The flowing coating material is then uniformly applied onto both side surfaces of the extrusion material by the constant pressure air blown from the first and second side air knives 342 and 343, as shown in FIG. 8. The excess coating liquid remaining after the coating flows into the coating liquid storage tank 332 through a collecting hopper 305 installed below the base 301. On the other hand, if only the upper surface (2-D surface) of the extrusion material 1 should be coated, the first and second side air knifes can be turned to any other directions since it is not necessary to use them.

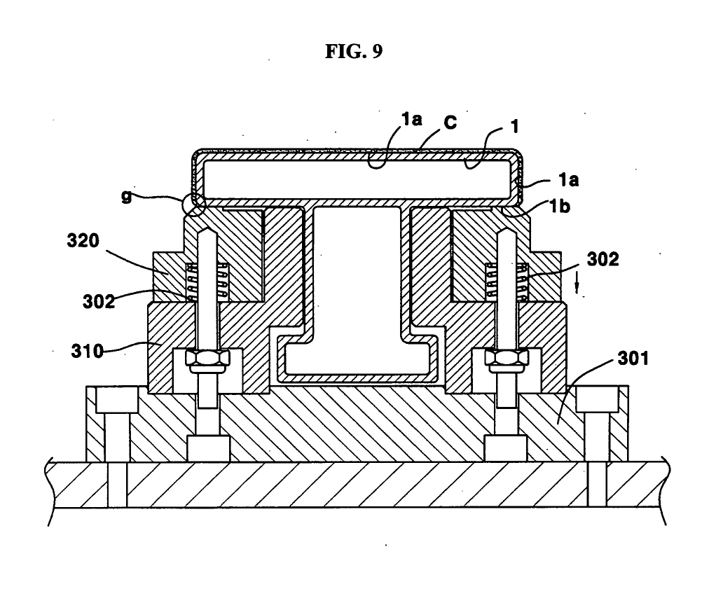

During such a coating process of the coating liquid, as shown in FIG. 9, the upward elastic force of the elastic members 302 causes the movable rails 320 to be brought into close contact with a lower surface of the extrusion material 1 such that the lower surface, i.e. the non-coating surface, of the extrusion material can be isolated from both side surfaces, i.e. the coating surfaces, of the extrusion material. Therefore, it is possible to prevent the coating material from being transferred from the coating surface to the non-coating surface.

A second embodiment of the coating apparatus is different from the first embodiment only in view of the configuration of a rail unit, but it has the same coating unit and air knife as the first embodiment. Thus, the descriptions of the other components except the rail unit will be omitted herein in order to avoid repeated descriptions.

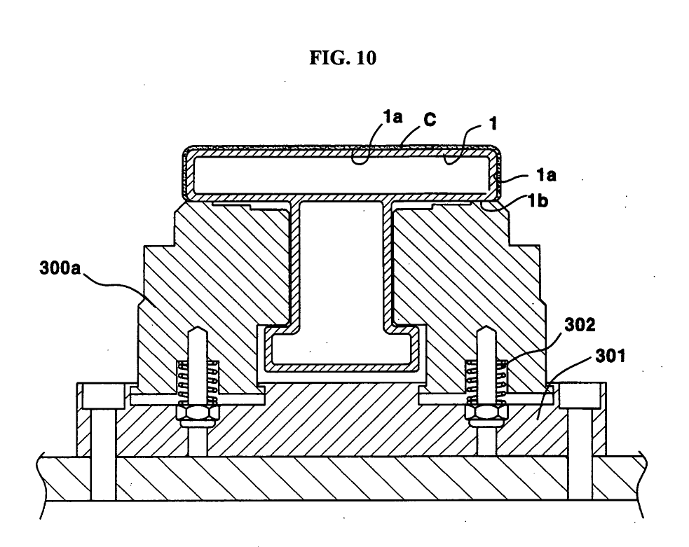

As shown in FIG. 10, a rail unit 300a of the second embodiment comprises a single body which is different from the first embodiment wherein the rail unit is separated into two bodies. The elastic members 302 are interposed between the rail unit 300a and the base 301 such that the rail unit can be elastically moved as a whole.

A third embodiment of the coating apparatus is different from the first embodiment only in view of the configuration of a rail unit, but it has the same coating unit and air knife as the first embodiment. Thus, the descriptions of the other components except the rail unit will also be omitted herein in order to avoid repeated descriptions.

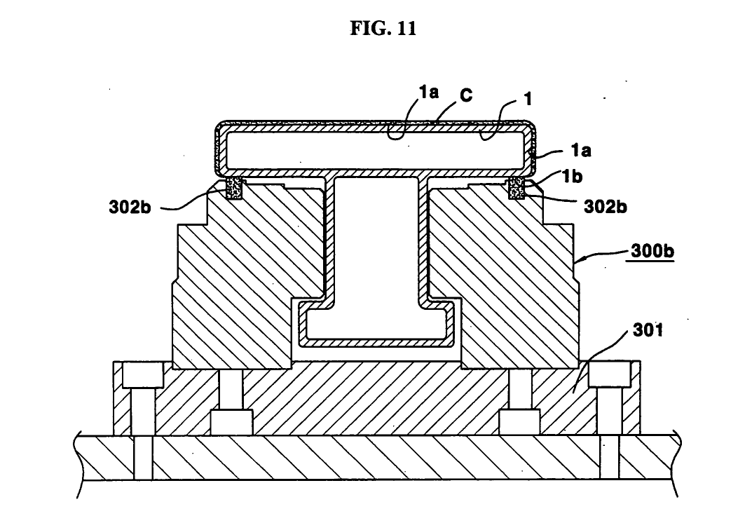

As shown in FIG. 11, a rail unit 300b of the third embodiment is configured in such a manner that elastic members 302b for isolating the coating surface 1a and the non-coating surface 1b from each other are installed at portions on which the extrusion material 1 is supported. Here, the elastic members 302b are made of urethane, but not limited thereto. That is, all soft and elastic members can be employed. However, it should be noted that the elastic member with a certain degree of durability is preferably employed considering that the friction between the elastic members and the extrusion material is continuously produced.

A fourth embodiment of the coating apparatus is different from the first embodiment in that the rail units are different from each other and an air supply means is provided in the fourth embodiment, but it has the same coating unit and air knife as the first embodiment. Thus, the descriptions of the same components will be omitted herein.

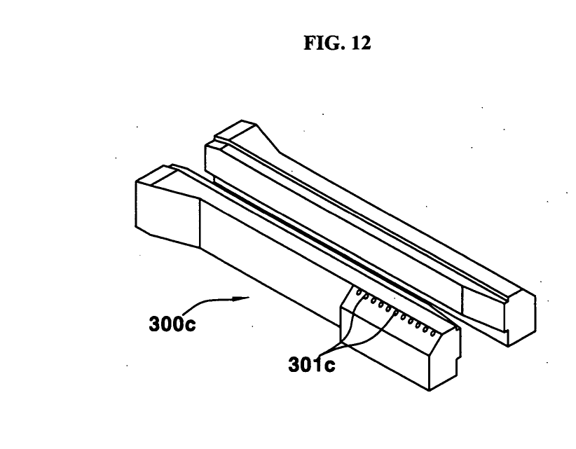

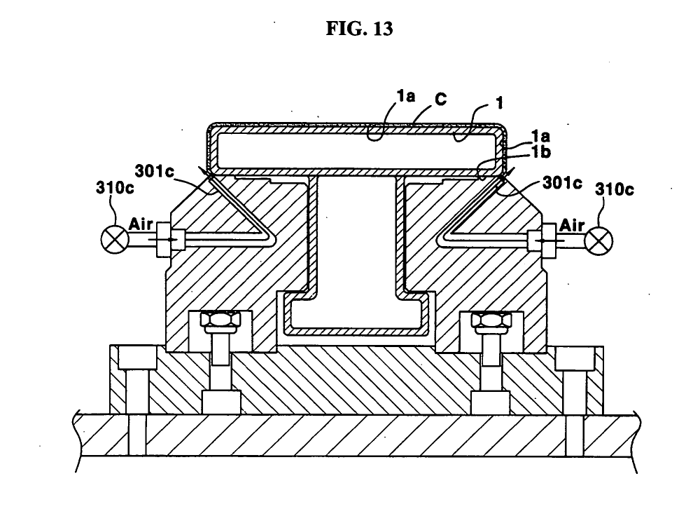

As shown in FIGS. 12 and 13, a rail unit 300c of the fourth embodiment is formed with air nozzles 301c, which are directed to boundaries between the coating surface 1a and the non-coating surface 1b of the extrusion material 1. Further, air supply means 310c for supplying the air nozzles with air are provided. A ring blower, a compressor or the like may be employed as the air supply mean.

Here, the size, the number and the like of the air nozzles are determined by considering the pressure or volume of the laminar-flow air. When the pressure of the laminar-flow air is high, the size of the air nozzles should become larger. When fine surface treatment is required, the size of the air nozzles should become smaller. The velocity and pressure of the air passing through the air nozzles 301c can be controlled by means of an external device such as a venturi tube.

The air nozzles 301c blow the air in a direction opposite to the direction in which the coating material flows in the non-coating surface, in order to prevent the coating liquid flowing from the coating surface 1a from flowing in the non-coating surface 1b, thereby serving to prevent the coating liquid from flowing in the non-coating surface.

Next, a method for coating a 2-D or 3-D extrusion material according to the present invention will be described.

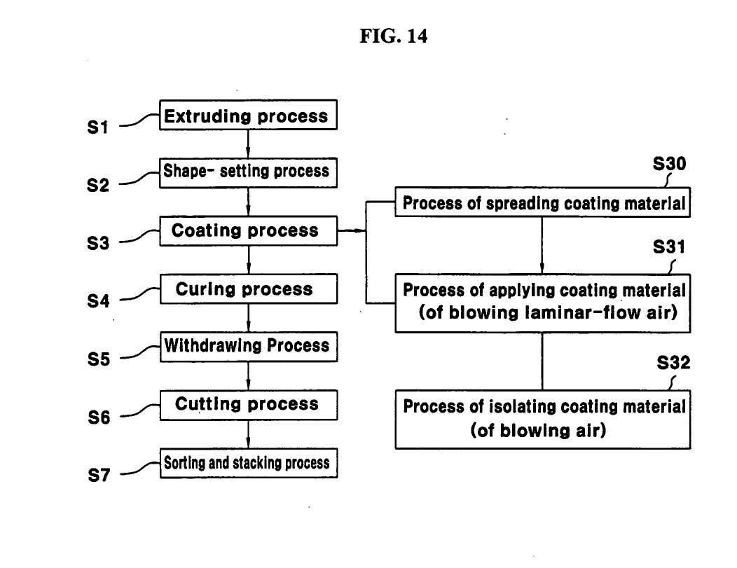

As shown in FIG. 14, the method for manufacturing an extrusion material according to the present invention comprises: a step S1 of extruding molten thermoplastic resin into a 2-D or 3-D shape; a step S2 of shape setting the extrusion material, which is not completely cured, by vacuum holding a surface of the extrusion material to maintain the shape of the extrusion material; a step S3 of coating a desired surface (a single surface or multiple surfaces) of the extrusion material 1 with the coating liquid; a step S4 of curing the coating liquid with which the extrusion material is coated; a step S5 of withdrawing the coated extrusion material; a step S6 of cutting the withdrawn extrusion material into an appropriate size; and a step S7 of sorting and stacking the cut extrusion material.

The coating step S3 comprises a step S30 of applying a certain amount of the coating material C to the specific surface of the extrusion material at random; and a step S31 of coating the surface of the extrusion material with the coating liquid at an uniform thickness by blowing air at a constant pressure (i.e., blowing the laminar-flow air) to the coating liquid applied onto the extrusion material and diffusing the coating liquid over the surface of the extrusion material in a state where a coating surface 1a and a non-coating surface 1b of the extrusion material are isolated from each other.

Alternatively, the coating step S3 may comprise a step S30 of applying a certain amount of the coating material C to the specific surface of the extrusion material 1 at random; and a step S32 of coating the surface of the extrusion material with the coating liquid at an uniform thickness by blowing air at a constant pressure (i.e., blowing the laminar-flow air) to the coating liquid applied onto the extrusion material and diffusing the coating liquid over the surface of the extrusion material wherein the coating liquid is prevented from flowing in the non-coating surface by blowing air from the non-coating surface 1b to coating surface 1a of the extrusion material.

The thickness of the coating formed on the surface of the extrusion material through the laminar-flow air blowing process of the former and the latter and the air blowing process of the latter can vary according to the linear velocity of the extrusion material, the viscosity of the paint, the pressure and volume of air, and the distance between the extrusion material and the air nozzles. Thus, the thickness of the coating to be formed on the surface of the extrusion material can be adjusted using the mutual relationship between the parameters listed above.

In the meantime, the curing step is performed differently according to whether the coating material is cured by heat or ultraviolet rays. The ultraviolet curable coating material can be cured by ultraviolet lamps (not shown) installed in the curing apparatus 40, whereas the thermosetting coating material can be cured by heating elements such as hot wires (not shown).

According to the present invention as described above, there is an advantage in that the single surface or multiple surfaces of the 2-D or 3-D extrusion material can be simply coated without defects.

Further, since the sealing state between the rails and the extrusion material is maintained such that the coating liquid cannot be introduced into the non-coating portions during the coating process, there is another advantage in that the quality of the coating process can be increased.

The scope of the present invention is not limited to the embodiments described and illustrated above but is defined by the appended claims. It will be apparent that those skilled in the art can make various modifications and changes thereto within the scope of the invention defined by the claims. Therefore, the true scope of the present invention should be defined by the technical spirit of the appended claims.

1. An apparatus for coating a surface of a 2-D or 3-D extrusion material, comprising:
a rail unit installed on a base with an elastic member interposed therebetween to be elastically and vertically movable, thereby serving to isolate a coating surface and a non-coating surface from each other while elastically supporting the delivered 2-D or 3-D extrusion material;
a coating unit for applying a certain amount of coating liquid to the specific coating surface of the extrusion material at random; and
an air knife for blowing air at a constant pressure to the coating liquid applied onto the extrusion material and diffusing the coating liquid to apply the coating liquid at a uniform thickness on the coating surface of the extrusion material.

2. An apparatus for coating a surface of a 2-D or 3-D extrusion material, comprising:
a rail unit including a fixed rail fixedly installed on a base and a movable rail installed on the fixed rail to be elastically and vertically movable by an elastic member, thereby serving to isolate a coating surface and a non-coating surface from each other while elastically supporting the 2-D or 3-D extrusion material;
a coating unit for applying a certain amount of coating liquid to the specific coating surface of the extrusion material at random; and
an air knife for blowing air at a constant pressure to the coating liquid applied onto the extrusion material and diffusing the coating liquid to apply the coating liquid at a uniform thickness on the coating surface of the extrusion material.

3. The apparatus as claimed in claim 1, wherein the elastic member includes a coil spring.

4. An apparatus for coating a surface of a 2-D or 3-D extrusion material, comprising:
a rail unit mounted with an elastic member for isolating a coating surface and a non-coating surface from each other at a portion on which the 2-D or 3-D extrusion material is supported;
a coating unit for applying a certain amount of coating liquid to the specific coating surface of the extrusion material at random; and
an air knife for blowing air at a constant pressure to the coating liquid applied onto the extrusion material and diffusing the coating liquid to apply the coating liquid at a uniform thickness on the coating surface of the extrusion material.

5. The apparatus as claimed in claim 4, wherein the elastic member is made of urethane.

6. The apparatus as claimed in claim 1, wherein the air knife includes an upper side air knife for blowing air to an upper surface of the extrusion material, a first side air knife for blowing air to a side surface of the extrusion material, and a second side air knife for blowing air to another side surface of the extrusion material.

7. The apparatus as claimed in claim 6, wherein a position and angle of each of the upper, first and second side air knives is adjustable.

8. The apparatus as claimed in claim 1, wherein a position and angle of the air knife is adjustable.

9. An apparatus for coating a surface of a 2-D or 3-D extrusion material, comprising:
a rail unit including an air nozzle directed to a boundary between a coating surface and a non-coating surface of the 2-D or 3-D extrusion material;
an air supply means for supplying the air nozzle with air;
a coating unit for applying a certain amount of coating liquid to the specific coating surface of the extrusion material at random; and
an air knife for blowing air at a constant pressure to the coating liquid applied onto the extrusion material and diffusing the coating liquid to apply the coating liquid at a uniform thickness on the coating surface of the extrusion material.

10. The apparatus as claimed in claim 1, wherein an upper end of an extrusion material inlet side of the rail unit is gently inclined.

11. The apparatus as claimed in claim 1, wherein the coating unit includes a coating liquid injection nozzle installed over an upper surface of the extrusion material, a coating liquid storage tank for storing the coating liquid therein, and a pulseless metering pump for supplying the coating liquid injection nozzle with the coating liquid in the coating liquid storage tank.

12. The apparatus as recited in claim 1, wherein the apparatus is included in equipment for manufacturing the extrusion material that comprises an extruding apparatus for extrusion molding molten thermoplastic resin into a 2-D or 3-D shape; a shape-setting apparatus for maintaining the shape of the extrusion material by vacuum holding the surface of the extrusion material to prevent the extrusion material from being deformed; a coating apparatus for coating the desired portion of the extrusion material with a coating material; a curing apparatus for curing the coating material; a withdrawing apparatus for withdrawing the coated extrusion material to the outside; a cutting apparatus for cutting the withdrawn extrusion material into an appropriate size; and a stacker for sorting and stacking the cut extrusion material.

13. The apparatus as recited in claim 2, wherein the apparatus is included in equipment for manufacturing the extrusion material that comprises an extruding apparatus for extrusion molding molten thermoplastic resin into a 2-D or 3-D shape; a shape-setting apparatus for maintaining the shape of the extrusion material by vacuum holding the surface of the extrusion material to prevent the extrusion material from being deformed; a coating apparatus for coating the desired portion of the extrusion material with a coating material; a curing apparatus for curing the coating material; a withdrawing apparatus for withdrawing the coated extrusion material to the outside; a cutting apparatus for cutting the withdrawn extrusion material into an appropriate size; and a stacker for sorting and stacking the cut extrusion material.

14. The apparatus as recited in claim 4, wherein the apparatus is included in equipment for manufacturing the extrusion material that comprises an extruding apparatus for extrusion molding molten thermoplastic resin into a 2-D or 3-D shape; a shape-setting apparatus for maintaining the shape of the extrusion material by vacuum holding the surface of the extrusion material to prevent the extrusion material from being deformed; a coating apparatus for coating the desired portion of the extrusion material with a coating material; a curing apparatus for curing the coating material; a withdrawing apparatus for withdrawing the coated extrusion material to the outside; a cutting apparatus for cutting the withdrawn extrusion material into an appropriate size; and a stacker for sorting and stacking the cut extrusion material.

15. The apparatus as recited in claim 9, wherein the apparatus is included in equipment for manufacturing the extrusion material that comprises an extruding apparatus for extrusion molding molten thermoplastic resin into a 2-D or 3-D shape; a shape-setting apparatus for maintaining the shape of the extrusion material by vacuum holding the surface of the extrusion material to prevent the extrusion material from being deformed; a coating apparatus for coating the desired portion of the extrusion material with a coating material; a curing apparatus for curing the coating material; a withdrawing apparatus for withdrawing the coated extrusion material to the outside; a cutting apparatus for cutting the withdrawn extrusion material into an appropriate size; and a stacker for sorting and stacking the cut extrusion material.

16. The apparatus as recited in claim 1, wherein the apparatus is included in equipment for manufacturing the extrusion material that comprises an input apparatus for inputting a curable extrusion material which has been extrusion molded into a 2-D or 3-D shape and cut into an appropriate size; a cleaning apparatus for cleaning the input extrusion material; a coating apparatus for coating a desired portion of the extrusion material with a coating material; a curing apparatus for curing the coating material; a delivery apparatus for delivering the extrusion material; and a stacker for sorting and stacking the extrusion material.

17. The apparatus as recited in claim 2, wherein the apparatus is included in equipment for manufacturing the extrusion material that comprises an input apparatus for inputting a curable extrusion material which has been extrusion molded into a 2-D or 3-D shape and cut into an appropriate size; a cleaning apparatus for cleaning the input extrusion material; a coating apparatus for coating a desired portion of the extrusion material with a coating material; a curing apparatus for curing the coating material; a delivery apparatus for delivering the extrusion material; and a stacker for sorting and stacking the extrusion material.

18. The apparatus as recited in claim 4, wherein the apparatus is included in equipment for manufacturing the extrusion material that comprises an input apparatus for inputting a curable extrusion material which has been extrusion molded into a 2-D or 3-D shape and cut into an appropriate size; a cleaning apparatus for cleaning the input extrusion material; a coating apparatus for coating a desired portion of the extrusion material with a coating material; a curing apparatus for curing the coating material; a delivery apparatus for delivering the extrusion material; and a stacker for sorting and stacking the extrusion material.

19. The apparatus as recited in claim 9, wherein the apparatus is included in equipment for manufacturing the extrusion material that comprises an input apparatus for inputting a curable extrusion material which has been extrusion molded into a 2-D or 3-D shape and cut into an appropriate size; a cleaning apparatus for cleaning the input extrusion material; a coating apparatus for coating a desired portion of the extrusion material with a coating material; a curing apparatus for curing the coating material; a delivery apparatus for delivering the extrusion material; and a stacker for sorting and stacking the extrusion material.

20. A method for coating a surface of a 2-D or 3-D extrusion material, comprising:
applying a certain amount of a coating material to the specific surface of the 2-D or 3-D extrusion material at random;
coating the surface of the extrusion material with the coating liquid at an uniform thickness by blowing air at a constant pressure to the coating liquid applied onto the extrusion material and diffusing the coating liquid in a state where a coating surface and a non-coating surface of the extrusion material are isolated from each other; and
curing the coating liquid by applying heat or irradiating ultraviolet rays to the coating liquid.

21. A method for coating a surface of a 2-D or 3-D extrusion material, comprising:
applying a certain amount of a coating material to the specific surface of the 2-D or 3-D extrusion material at random;
coating the surface of the extrusion material with the coating liquid at an uniform thickness by blowing air at a constant pressure to the coating liquid applied onto the extrusion material and diffusing the coating liquid, wherein the coating liquid is prevented from flowing in the non-coating surface by blowing air from the non-coating surface to the coating surface of the extrusion material; and
curing the coating liquid by applying heat or irradiating ultraviolet rays to the coating liquid.

22. A method for coating a surface of a 2-D or 3-D extrusion material, which is included in a method for manufacturing the extrusion material that comprises: extruding molten thermoplastic resin into a 2-D or 3-D shape; shape setting the extrusion material by vacuum holding the surface of the extrusion material to maintain the shape of the extrusion material; coating a desired portion of the extrusion material; curing the coating liquid with which the extrusion material is coated; withdrawing the coated extrusion material; cutting the withdrawn extrusion material into an appropriate size; and sorting and stacking the cut extrusion material, the coating method comprising:
applying a certain amount of a coating material to the specific surface of the 2-D or 3-D extrusion material at random;
coating the surface of the extrusion material with the coating liquid at an uniform thickness by blowing air at a constant pressure to the coating liquid applied onto the extrusion material and diffusing the coating liquid in a state where a coating surface and a non-coating surface of the extrusion material are isolated from each other; and
curing the coating liquid by applying heat or irradiating ultraviolet rays to the coating liquid.

23. A method for coating a surface of a 2-D or 3-D extrusion material, which is included in a method for manufacturing the extrusion material that comprises extruding molten thermoplastic resin into a 2-D or 3-D shape; shape setting the extrusion material by vacuum holding the surface of the extrusion material to maintain the shape of the extrusion material; coating a desired portion of the extrusion material; curing the coating liquid with which the extrusion material is coated; withdrawing the coated extrusion material; cutting the withdrawn extrusion material into an appropriate size; and sorting and stacking the cut extrusion material, the coating method comprising:
applying a certain amount of a coating material to the specific surface of the 2-D or 3-D extrusion material at random;
coating the surface of the extrusion material with the coating liquid at an uniform thickness by blowing air at a constant pressure to the coating liquid applied onto the extrusion material and diffusing the coating liquid, wherein the coating liquid is prevented from flowing in the non-coating surface by blowing air from the non-coating surface to the coating surface of the extrusion material; and
curing the coating liquid by applying heat or irradiating ultraviolet rays to the coating liquid.

24. The apparatus as claimed in of claim 1, wherein the 2D extrusion material is a cover fitted in a surface of a window frame, and the 3D extrusion material is a sash or window frame.

25. The method as claimed in claim 20 wherein the 2D extrusion material is a cover fitted in a surface of a window frame, and the 3D extrusion material is a sash or window frame.

26. The apparatus as claimed in claim 2, wherein the elastic member includes a coil spring.

27. The apparatus as claimed in claim 2, wherein the air knife includes an upper side air knife for blowing air to an upper surface of the extrusion material, a first side air knife for blowing air to a side surface of the extrusion material, and a second side air knife for blowing air to another side surface of the extrusion material.

28. The apparatus as claimed in claim 27, wherein a position and angle of each of the upper, first and second side air knives is adjustable.

29. The apparatus as claimed in claim 4, wherein the air knife includes an upper side air knife for blowing air to an upper surface of the extrusion material, a first side air knife for blowing air to a side surface of the extrusion material, and a second side air knife for blowing air to another side surface of the extrusion material.

30. The apparatus as claimed in claim 29, wherein a position and angle of each of the upper, first and second side air knives is adjustable.

31. The apparatus as claimed in claim 2, wherein a position and angle of the air knife is adjustable.

32. The apparatus as claimed in claim 4, wherein a position and angle of the air knife is adjustable.

33. The apparatus as claimed in claim 2, wherein an upper end of an extrusion material inlet side of the rail unit is gently inclined.

34. The apparatus as claimed in claim 4, wherein an upper end of an extrusion material inlet side of the rail unit is gently inclined.

35. The apparatus as claimed in claim 9, wherein an upper end of an extrusion material inlet side of the rail unit is gently inclined.

36. The apparatus as claimed in claim 2, wherein the coating unit includes a coating liquid injection nozzle installed over an upper surface of the extrusion material, a coating liquid storage tank for storing the coating liquid therein, and a pulseless metering pump for supplying the coating liquid injection nozzle with the coating liquid in the coating liquid storage tank.

37. The apparatus as claimed in claim 4, wherein the coating unit includes a coating liquid injection nozzle installed over an upper surface of the extrusion material, a coating liquid storage tank for storing the coating liquid therein, and a pulseless metering pump for supplying the coating liquid injection nozzle with the coating liquid in the coating liquid storage tank.

38. The apparatus as claimed in claim 9, wherein the coating unit includes a coating liquid injection nozzle installed over an upper surface of the extrusion material, a coating liquid storage tank for storing the coating liquid therein, and a pulseless metering pump for supplying the coating liquid injection nozzle with the coating liquid in the coating liquid storage tank.

39. The apparatus as claimed in claim 2, wherein the 2D extrusion material is a cover fitted in a surface of a window frame, and the 3D extrusion material is a sash or window frame.

40. The apparatus as claimed in claim 4, wherein the 2D extrusion material is a cover fitted in a surface of a window frame, and the 3D extrusion material is a sash or window frame.

41. The apparatus as claimed in claim 9, wherein the 2D extrusion material is a cover fitted in a surface of a window frame, and the 3D extrusion material is a sash or window frame.

42. The apparatus as claimed in claim 12, wherein the 2D extrusion material is a cover fitted in a surface of a window frame, and the 3D extrusion material is a sash or window frame.

43. The apparatus as claimed in claim 13, wherein the 2D extrusion material is a cover fitted in a surface of a window frame, and the 3D extrusion material is a sash or window frame.

44. The apparatus as claimed in claim 14, wherein the 2D extrusion material is a cover fitted in a surface of a window frame, and the 3D extrusion material is a sash or window frame.

45. The apparatus as claimed in claim 15, wherein the 2D extrusion material is a cover fitted in a surface of a window frame, and the 3D extrusion material is a sash or window frame.

46. The apparatus as claimed in claim 16, wherein the 2D extrusion material is a cover fitted in a surface of a window frame, and the 3D extrusion material is a sash or window frame.

47. The apparatus as claimed in claim 17, wherein the 2D extrusion material is a cover fitted in a surface of a window frame, and the 3D extrusion material is a sash or window frame.

48. The apparatus as claimed in claim 18, wherein the 2D extrusion material is a cover fitted in a surface of a window frame, and the 3D extrusion material is a sash or window frame.

49. The apparatus as claimed in claim 19, wherein the 2D extrusion material is a cover fitted in a surface of a window frame, and the 3D extrusion material is a sash or window frame.

50. The method as claimed in claim 21, wherein the 2D extrusion material is a cover fitted in a surface of a window frame, and the 3D extrusion material is a sash or window frame.

51. The method as claimed in claim 22, wherein the 2D extrusion material is a cover fitted in a surface of a window frame, and the 3D extrusion material is a sash or window frame.

52. The method as claimed in claim 23, wherein the 2D extrusion material is a cover fitted in a surface of a window frame, and the 3D extrusion material is a sash or window frame.
